(19) United States
(12) Patent Application Publication
(10) Pub. No.: US 2014/0304949 A1
(43) Pub. Date: Oct. 16, 2014

(54) EASY HANDLE

(71) Applicant: Michael Denton, Crestline, CA (US)

(72) Inventor: Michael Denton, Crestline, CA (US)

(21) Appl. No.: 14/253,756

(22) Filed: Apr. 15, 2014

Related U.S. Application Data
(60) Provisional application No. 61/812,181, filed on Apr. 15, 2013.

(51) Int. Cl. B25G 1/10; B25G 3/36

(52) U.S. Cl. CPC B25G 1/102; B25G 3/36
USPC 16/430

(57) ABSTRACT

The Easy Handle is an adjustable and ergonomic handle that is attached easily to the shaft of any tool with an elongated handle comprising a semi cylindrical clamp fitting in the form of two expandable semi-circular arms defining an annular substantially circular opening. Culminating from the base of the clamp fitting two arms extend outwards from the cylindrical base clamp fitting and terminate in a hand grip.

### CLAIM OF PRIORITY

This patent application claims priority under 35 USC 119 (e) (1) from U.S. Provisional Patent Application Ser. No. 61/812,181 filed Apr. 15, 2013, of common inventorship herewith entitled, “Easy Handle.”

### FIELD OF THE INVENTION

The present invention pertains to the field of lawn and garden tools, and more specifically to the field of gripping handles for lawn and garden tools.

### BACKGROUND OF THE INVENTION

The prior art has put forth several designs for gripping handles for lawn and garden tools. Among these are:

U.S. Pat. No. 5,547,349 to Lloyd B. Coble describes an auxiliary handle for shovels or the like having a shaft with an adjustable length, a clamp for attachment to the shaft of a conventional shovel near the blade and a swivel linkage connecting the shaft to the clamp, which allows full swiveling of the auxiliary handle relative to the shaft of the shovel. Load, lift and discharge assistance provided by this handle minimizes back exertion during shovel operations.

U.S. Pat. No. 2,531,227 to Max C. Walter describes a shovel with an auxiliary handle comprised of a blade, a main grip, a main shank between and rigidly connected to the blade and main grip.

US Patent 2007/0289103 to Joel P. Steelman describes a grip that is readily attached and adjustable as a second or third auxiliary handle to handheld tools that have elongated cylindrical handles which vary in diameter. These handles have surfaces that are more or less than parallel to their axis and require no sleeves or shims be added. The need for any tools to attach or adjust is negated and the portion gripped by the hand rotates, preventing any abrasive contact between the user and the attachment or the tool.

None of these prior art references describe the present invention.

### SUMMARY OF THE INVENTION

It is an object of the present invention to provide an ergonomic grip handle installable on a handle shaft of lawn and garden tools such as shovels, hoes and rakes.

### BRIEF DESCRIPTION OF THE DRAWINGS

FIG. 1 is a prototypical front view showing a grip handle with nut and bolt tightening capability and installable on a lawn and garden tool handle.

FIG. 2 is a prototypical functional full diagonal view showing a grip handle installed on a shovel.

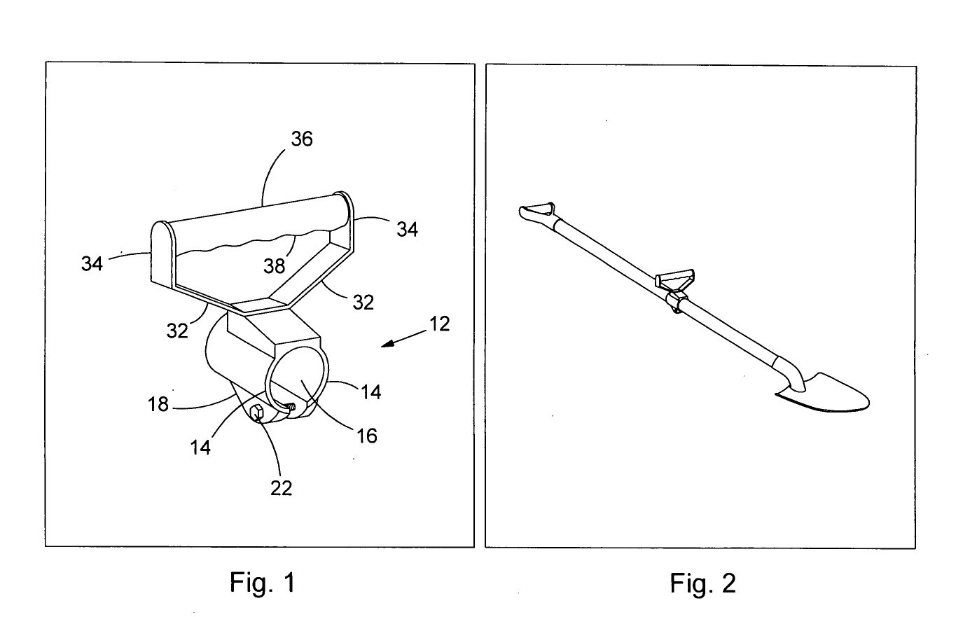

### DETAILED DESCRIPTION OF THE INVENTION

Gardening and landscaping are important and satisfying aspects of home ownership for both men and women. As these activities allow people to use both the intellect and physical strength, they contribute to creating a tangible and enjoyable environment. Whether bordering a home with a vibrant collection of floral beauties, pruning hedges to alluring and intricate shapes, fashioning a vegetable garden to supply fresh foods, or simply mowing a lawn to attractive precision, lawn and garden enthusiasts find joy, relaxation, and a sense of accomplishment in improving the outside appearance of their home. While yard work provides satisfaction for the spirit and exercise for the body, many people find that simple activities such as shoveling dirt in a garden, raking fall leaves or even hoeing a flower bed are physically taxing. Maintaining a firm grip on a handle while lifting a shovel that is loaded with snow is very strenuous physically, resulting in one becoming stiff and sore even after working only a short time. Despite a willingness and desire to rake fallen leaves, cultivate weeds from a flower bed or to till the earth to plant a tree, those people suffering from physical disabilities are forced by painful limitations to refrain from engaging in such gratifying outdoor projects.

The present invention, hereinafter referred to as The Easy Handle, is an ergonomic handle configured expressly to be installed on the shaft of shovels, hoes, rakes and similar lawn and garden tools. The Easy Handle provides gardeners, landscapers, general household consumers, farmers and ranchers with a practical tool which makes standard long handled tools more comfortable to use. The Easy Handle also is incorporated into newly manufactured lawn and garden tools.

The Easy Handle is an adjustable and ergonomic handle that is attached easily to the shaft of any tool with an elongated handle. The Easy Handle is attached to the shaft of the tool, directly above the actual head of the tool. The placement of the easy handle can be adjusted to accommodate users with differing arm lengths. The user maintains a firmer grip and greater leverage, alleviating painful exertion of the hand as the tool is lifted or otherwise utilized.

The Easy Handle is manufactured primarily of shatterproof plastic or durable metal material. The present invention accommodates a handle of virtually any long handled lawn or garden tool. The Easy Handle's base comprises a semi cylindrical clamp fitting 12 in the form of two expandable semi-circular arms 14 defining an annular substantially circular opening 16. The circular opening 16 is shaped and designed to receive the handle shaft of a tool. Extended portions 18, or flanges extend from semicircular arms 14, and include at least one aperture, for receiving a threaded bolt 22, or wing nut therethrough. The bolt is secured by a nut or wing nut. The bolt or simple wing nut is included to slide over the bolt's end, enabling a user to tighten the flanges of the cylindrical clamp fitting over the handle and solidly secure the present invention in place. This configuration enables a user to easily loosen and slide The Easy Handle up or down a shaft of a tool handle to best position the present invention in accordance to their stature and comfort.

In an alternative embodiment, the flange extensions can comprise two holes for securing the device on the shaft of a tool. Culminating from the base of the clamp fitting is a hand grip comprising two arms 32 extending outwards from the cylindrical base clamp fitting. The arms 32 straighten into vertical sections 34. The vertical sections 34 are joined together at their distal ends by means of an extended ergonomic handle grip 36 containing indentations 38 to accommodate individual fingers. The handle grip of the present invention can be coated in textured rubber or similar material to further facilitate ease of use.

Using The Easy Handle is very simple and straight forward. A user purchases one or more Easy Handles to attach to their existing lawn and garden tools, or a user purchases tools with The Easy Handle already incorporated into them. Installing The Easy Handle involves sliding The Easy Handle's circular clamp fitting over a handle shaft of an existing tool. The user runs the threaded bolt through the circular fittings located in the center of each flange that extends from the fitting. The user adjusts the location of The Easy Handle, sliding it up or down the tool's shaft to position it for optimal comfort. The user applies the wing nut fastener to the bolt and tightens the wing nut to draw the flanges together and secure the present invention in place. Grasping the top of the tool handle as usual, the user utilizes their free hand to grasp The Easy Handle and provide greater comfort and superior leverage of the tool when raking, shoveling, hoeing or performing other tasks.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An ergonomic handle installable on a handle shaft of a tool, comprising: an adjustable and ergonomic handle that is attached easily to the shaft of any tool with an elongated handle wherein the handle comprises a base having a semi cylindrical clamp fitting in the form of two expandable semi-circular arms defining an annular substantially circular opening, wherein the circular opening is shaped and designed to receive the handle shaft of a tool, and further comprising two extended portions, or flanges extending from the semicircular arms, wherein each flange includes at least one aperture, for receiving a threaded bolt therethrough, further comprising comprising two arms extending outwards from the cylindrical base clamp fitting, wherein the arms straighten into vertical sections and the vertical sections are joined together at their distal ends by means of an extended ergonomic handle grip.

2. The ergonomic handle of claim 1 wherein the handle grip further comprises indentations to accommodate individual fingers.

3. The ergonomic handle of claim 1 wherein the handle grip is coated in textured rubber or similar material to further facilitate ease of use.

4. The ergonomic handle of claim 1 wherein the handle grip wherein the two extended portions or flanges each include two apertures for receiving a bolt.

5. The ergonomic handle of claim 1 wherein the handle grip wherein the apertures are threaded.
